(19) United States
(12) Patent Application Publication
(10) Pub. No.: US 2025/0110054 A1
(43) Pub. Date: Apr. 3, 2025

(54) SINGLE-LENS PATHWAY FOR EMISSION AND EXCITATION USING A MIRROR AND BEAM SPLITTER IN A CUSTOMIZABLE OPTICAL HEAD

(71) Applicant: AlpHa Measurement Solutions, LLC, Houston, TX (US)

(72) Inventors: Thomas D. Brumett, JR., Clayton, NC (US); Thomas D. Brumett, III, Clayton, NC (US)

(21) Appl. No.: 18/903,197

(22) Filed: Oct. 1, 2024

Related U.S. Application Data
(60) Provisional application No. 63/587,340, filed on Oct. 2, 2023.

(51) Int. Cl. G01N 21/64; G02B 17/08

(52) U.S. Cl. CPC G01N 21/645; G02B 17/0868; G02B 17/0876

(57) ABSTRACT

A small form factor optical head defines a single light pathway. The optical head includes a housing, a lens positioned on or in the housing, and a light source positioned in the housing to emit an excitation light. A mirror is positioned in the housing to reflect the excitation light to the lens and to receive emission light back through the lens, and a beamsplitter positioned in the housing directs the excitation light to the lens and directs the emission light to a detector that receives emission light after passing back through the lens and the beam splitter. The lens, the mirror, and the beam splitter define a single light pathway for the excitation light and emission light. A method for optical analysis is also disclosed.

### BACKGROUND

The following description relates to optical systems and the design of a compact, customizable optical head that uses a single optical pathway for both excitation and emission, and is intended for applications such as fluorometry, spectroscopy, or other optical analysis systems requiring compact, integrated designs.

Fluorometers measure parameters of visible spectrum fluorescence. Specifically, they measure the presence and amount of specific molecules in a medium by measuring the intensity and wavelength distribution of an emission spectrum after excitation by a specific spectrum of light. In optical systems such as fluorometers, it is common to use separate pathways for excitation light and emission detection, which can increase the complexity and size of the device.

Typically, small form factor fluorometers use an optical head having a double optical beam. The emission and excitations beams each having a separate pathway and lens within the optical head. The excitation beam is passed through a filter and through the sample. After the excitation light has reached the target, the emission beam is generated by the sample and passes through a lens, through an attenuator and is measured by the photodiode or measuring device. The optical beams are passed through separate lenses in the fluorometer optical head. The sample fluoresced light and the filtered beam are detected by transducers and converted to an electrical signal for interpretation.

One drawback to known devices is that they use an inefficient optical geometry. That is, these small form factor optical heads use a less than 90° measurement angle between the LED and photodiode. This requires tedious alignment operations of the optical elements during assembly and maintenance and often rely on complex arrangements of lenses and mirrors that add bulk and complexity to the system.

Accordingly, there is a need for an optical head for a fluorometer having a sectional configuration. Desirably, such an optical head uses sections that fit together in a specific way to encapsulate the filters and mirrors and allow for precise alignment for advanced fluorometric measurement. More desirably still, such an optical head includes upper, middle and lower housing sections to provide such precise component alignment. Still more desirably, in such an optical head the excitation and emission beams converge or share the same optical path to and from the target beyond a mirror, and as such only a single lens is needed.

### BRIEF SUMMARY

In an aspect, a small form factor optical head defines a single light pathway. The optical head includes a housing, a lens positioned on or in the housing, and a light source positioned in the housing. The light source is configured to emit an excitation light. In embodiments the light source can be a LED or a laser to produce the excitation light.

The optical head includes a mirror positioned in the housing to reflect the excitation light to the lens and to receive emission light back through the lens from the material being analyzed. To effect the single light pathway, the optical head includes a beamsplitter positioned in the housing to direct the excitation light to the lens and to direct the emission light to a detector. The detector can be, for example, a photodiode. The detector is positioned to receive emission light after passing back through the lens and the beam splitter.

The lens, the mirror, and the beam splitter define a single light pathway for the excitation light and emission light. In embodiments, the lens is adjustable. The lens can be a ball lens.

The optical head can further include one or more filters. The filters can be an emission filter in the emission beam and/or an excitation filter in the excitation beam.

In embodiments, the optical head includes a lens block. The mirror and the beamsplitter can be received in a first side of the lens block and the lens is in or on a second side of the lens block. The lens block can include a first lens block section configured to receive the light source, a second lens block section configured to receive one or more filters, and a third lens block section configured to receive the mirror and the beamsplitter. The first, second, and third lens block sections can be secured to one another and positioned in the housing as a unit.

In an aspect, a small form factor optical head defines a single light pathway and includes a housing, a lens, a light source positioned in the housing, a photodiode positioned in the housing, and a lens block positioned in or on the housing.

The optical head includes a mirror positioned in the housing, and first and second filters positioned in the housing. The lens block is configured to receive the light source, the photodiode, the first and second filters, the mirror and the beamsplitter in a first side thereof and the lens is positioned at a second side thereof. The lens is configured to focus the excitation light which is generated by an LED or laser and travels through an excitation filter (if needed), is then reflected from the mirror following a path to the beam splitter and through the lens. The emission light is generated at the source and passes through the lens to the beam splitter and emission filter (if needed), and then on to a detector. The lens can be, for example, a ball lens. The lens can be adjustable.

In another aspect, a method for optical analysis includes providing an optical head having a housing, a lens positioned on or in the housing, a light source positioned in the housing, the light source configured to emit an excitation light, a mirror positioned in the housing to reflect the excitation light to the lens and to receive emission light back through the lens, a beamsplitter positioned in the housing to direct the excitation light to the lens and to direct the emission light, and a detector positioned to receive emission light after passing back through the lens and the beam splitter, wherein the lens, the mirror, and the beam splitter define a single light pathway for the excitation light and emission light, emitting a light beam from the light source, receiving an emission beam, and analyzing the emission beam.

In another aspect, a small form factor optical head for example, for a fluorometer includes, a housing, a light emitting diode (LED) and a photodiode mounted to a printed circuit board, a lens and a lens block positioned in the housing. The lens block includes first, second and third lens block sections, first and second filters, a mirror and a beamsplitter.

The first lens block section is configured to receive the LED and the photodiode, the second lens block section is configured to receive the first and second filters, and the third lens block section is configured to receive the mirror and the lens splitter in a first side thereof and the lens in a second side thereof. The first, second, and third lens block sections are secured to one another and positioned in the housing as a unit. The excitation and emission beams converge or share the same optical path to and from the target beyond the mirror, and as such, only a single lens is needed.

The present optical head is provided is a compact, customizable form that uses a single lens pathway for both excitation and emission light. The optical head uses a mirror and a beam splitter, in which the beam splitter is positioned to direct excitation light toward the sample while allowing emitted light to pass back through the same lens for detection.

In aspects, the mirror reflects the excitation beam into the optical pathway, the beam splitter divides and directs the light, such that the excitation and emission light share the same pathway but do not interfere with each other. In such an optical head, a single lens serves both the excitation and emission processes, reducing the permitting a compact design and reducing complexity.

Further, such an optical head allows for a customizable design, enabling adaptation to various applications such as different wavelengths, magnifications, or configurations for specialized optical analyses.

The foregoing general description and the following detailed description are examples only and are not restrictive of the present disclosure. Other aspects, objectives and advantages will become more apparent from the following detailed description when taken in conjunction with the accompanying drawings.

### BRIEF DESCRIPTION OF THE DRAWINGS

The benefits and advantages of the present embodiments will become more readily apparent to those of ordinary skill in the relevant art after reviewing the following detailed description and accompanying drawings, wherein:

FIG. 1 is a cross-sectional view of an embodiment of a fluorometer optical head according to the present disclosure;

FIG. 2 is a cross-sectional view of an embodiment of a lens block;

FIGS. 3A and 3B are bottom (FIG. 3A) and top views of the lens block bottom block;

FIGS. 4A and 4B are top (FIG. 4A) and bottom views of the lens block middle block;

FIGS. 5A and 5B are top (FIG. 5A) and bottom views of the lens block top block;

FIG. 6 is a schematic cross-sectional illustration of the small form factor optical head; and

FIG. 7 illustrates an example of a ball lens for use in the optical head.

### DETAILED DESCRIPTION

While the present disclosure is susceptible of embodiment in various forms, there is shown in the drawings and will hereinafter be described presently preferred embodiments with the understanding that the present disclosure is to be considered an exemplification and is not intended to limit the disclosure to the specific embodiments illustrated.

In embodiments, as will be described below, a present optical head includes a light source, such as a laser or LED, to provide excitation light, a single lens that is placed in the optical path that both focuses the excitation light onto the sample and collects the emitted light. A beam splitter is positioned above the photodiode and excitation filter (if needed) and the mirror, which reflects the light 90 degrees toward the beam splitter, which reflects the light at 90 degrees toward the lens and the sample. In this configuration, the excitation light and the emitted light travel through the same pathway.

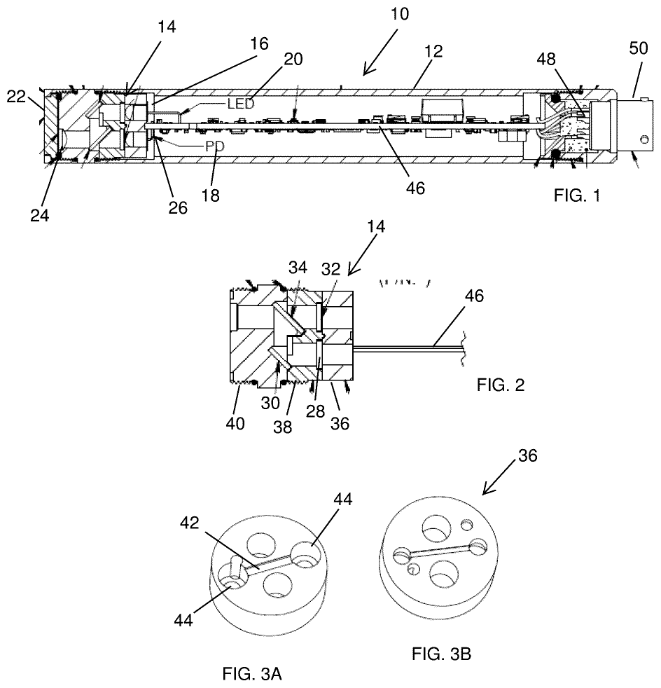

Referring now to the figures, and in particular to FIG. 1, there is shown an embodiment of an optical head 10 for use with, for example, a fluorometer according to the present disclosure. The optical head 10 includes, generally, a housing 12, a lens block 14, a PCB 16 with a photodiode 18 and a light source such as a LED 20 mounted thereto, a window 22, a lens 24, and a connector assembly 26. The housing 12 encloses the optical head components. The window 22, for example, a fused silica window is positioned at one end of the housing 12.

As seen in FIGS. 2-5B, the lens block 14 is configured to mount and position a laser clean up or excitation filter 28 and mirror 30, and an emission filter 32 and dichroic beamsplitter 34, and the lens 24. The lens block 14 is configured to mount the components in precise relationship to each other. In a current embodiment, the lens block 14 includes a lens bottom block 36, a lens middle block 38 and a lens top block 40. The three lens block sections 36, 38 and 40, are secured together to form the lens block 14.

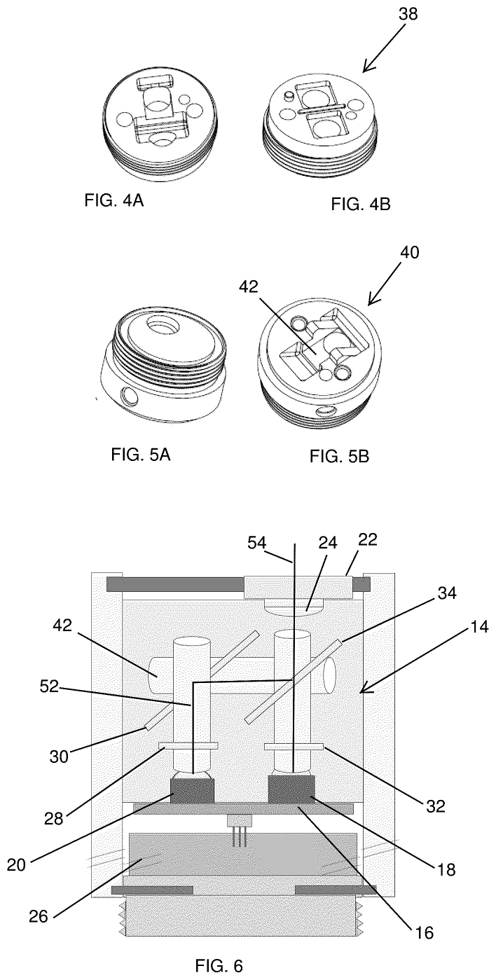

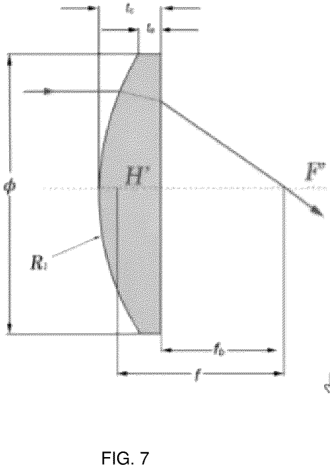

Referring to FIGS. 3A and 3B, the lens block bottom block 36 includes openings to receive the LED 20 and the photodiode 18. As seen in FIGS. 4A and 4B, the lens block middle block 38 is configured to receive the excitation and emission filters 28, 32. As seen in FIGS. 5A and 5B, the lens block top block 40 is configured to receive the mirror 30 and the dichroic beamsplitter 34. The bottom, middle and top blocks 36, 38, and 40 are assembled together with the respective components, and secured to each other to define the lens block 14. Channels 42 are formed in the lens block to provide optical paths for the beams. The lens block 14 is positioned in the housing 12, adjacent the window 22.

The PCB 16 with the photodiode 18 and LED 20 mounted thereto is positioned adjacent the lens block bottom block 36 such that the photodiode 18 and LED 20 are positioned in the lens bottom block openings 44. A fluorometer probe 46 extends from the PCB 16 to an opposite end of the housing 12 and pins 48 from the 46 probe are terminated at, for example, a connector 50 at the end of the housing 12. A mating connector (not shown), for example, a 6 pin connector can connect to the connector 50 terminated at the end of the probe 46.

In a present embodiment, there are two optical paths 52, 54 formed by the lens block 14. A first optical path 52 includes the LED 20, the excitation filter 28, and the mirror 30. The second optical path 54 includes the photodiode 18, the emission filter 32, and the dichroic beamsplitter 34. In a current embodiment, the excitation and emission filters 28, 32 are single-band bandpass filters, and the beamsplitter 34 is a single edge standard epi-fluorescence dichroic beamsplitter.

A single lens 24 provides for directing respective optical paths 52, 54 into and out of the optical head 10 through the window 22. In embodiments, the lens 24 is a targeting plano convex lens. Because the excitation and emission beams converge or share the same optical path to and from the target beyond the mirror 30, only a single lens 24 is needed.

Advantageously, the present optical head 10 uses a three-piece lens block 14 assembly which is assembled as a unit and which contains the cavities for the emission and excitation filters 32, 28, the targeting plano-convex lens 24, a mirror 30 and beam-splitter 34 arrangement structure and optical paths 52, 54 to allow for highly consistent fluorescent measurements across device to device. The plano-convex lens 24 brings the excitation beam to perfect focus.

The PCB 16 with the LED 20 and photodiode 18 elements attaches to the lens block 14 which guarantees precise alignment of the LED 20 and photodiode 18 into the optical path.

The light source, e.g., the LED 20, generates excitation light, which is directed toward the mirror 30. The mirror 30 reflects this light to the beam splitter 34. The beam splitter 34 directs the excitation light through the lens 24 onto the sample. The same lens 24 collects the emitted light from the sample, which passes back through the beam splitter 34 and is directed to the detector for analysis.

As noted above, the present optical head 10 includes two optical paths—the excitation path 52 and the excitation/emission path 54. The excitation beam from the LED 20 is diverted at 90° to the beam splitter 34 which directs the excitation beam 90° to the targeting lens 24. The emission beam emits from the target back through the lens 24, through the beam splitter 34 to the photodiode 18. Since the excitation and emission share the same optical path to and from the target beyond the mirror 30, the targeted focal point is not subject to any misalignment which can happen with separate excitation and emission pathways.

Further, since the optical head 10 assembly is a self-contained, self-aligning module with the LED/photodiode PCB 20/18/16 attached it is easy to change fluorometer application specifics by swapping out filters 28, 32. For example, a PTSA configured optical head easily swaps with a chlorophyl configured optical head. It is envisioned that this feature can be made available to users of the fluorometer. Also, since all optical elements are contained in the optical head assembly 10, these assemblies can be tested prior to being attached to the rest of the fluorometer, streamlining the manufacturing process.

One novel aspect of the present fluorometer optical head assembly is the multi-piece lens block 14 which aligns the LED 20 and photodiode 18 perfectly into the optical path. This structure provides for proper alignment of the optical elements during assembly, thus eliminating tedious alignment operations. That is, this configuration permits quick change out of the optic components while keeping the essential geometric orientation intact. Further, because the excitation and emission beams converge or share the same optical path to and from the target beyond the mirror 30, only a single lens 24 is needed.

The bottom, middle and top lens block sections 36, 38, 40 each fit together in a specific way to encapsulate the filters 28, 32 and mirror 30 and allow for precise alignment for advanced fluorometric measurement. The dichroic mirror 30 that is placed above the emission filter 32 essentially acts as a dual filtering process allowing for an extra layer of selective screening for the fluorescent measurement by the photodiode 18. The incorporation of the mirror 30 into this design is also a novel aspect of the present optical head 10. The mirror 30 is positioned above the LED 20 at a 45° angle. Optically, this places the LED 20 and photodiode 18 at a 90° angle from each other which is optimal for measuring fluorescence.

Those skilled in the art will appreciate the significant advantages over known optical heads. For example, The use of a single optical pathway reduces the overall size of the optical head, thus providing a compact design. By utilizing a beam splitter and mirror, the design minimizes optical losses and interference, all provided in a compact and efficiency form. Such an optical head can be as small as about ½″ to ¾″ in diameter, although various sizes can be configured. The present optical head is customizable and is thus designed to allow customization for different wavelengths, sample types, or analysis needs. The compact optical head is also cost effective in that it uses a simplified optical layout that reduces manufacturing complexity and cost.

All patents referred to herein, are hereby incorporated herein in their entirety, by reference, whether or not specifically indicated as such within the text of this disclosure.

In the present disclosure, the words “a” or “an” are to be taken to include both the singular and the plural. Conversely, any reference to plural items shall, where appropriate, include the singular. In addition, in is understood that terminology referring to directions or relative orientations, such as, but not limited to, “upper” “lower” “raised” “lowered” “top” “bottom” “above” “below” “alongside” “left” and “right” are used for purposes of example and do not limit the scope of the subject matter described herein to such orientations or relative positioning.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

What is claimed is:

1. A small form factor optical head defining a single light pathway, comprising:
a housing;
a lens positioned on or in the housing;
a light source positioned in the housing, the light source configured to emit an excitation light;
a mirror positioned in the housing to reflect the excitation light to the lens and to receive emission light back through the lens;
a beamsplitter positioned in the housing to direct the excitation light to the lens and to direct the emission light; and
a detector positioned to receive emission light after passing back through the lens and the beam splitter,
wherein the lens, the mirror, and the beam splitter define a single light pathway for the excitation light and emission light.

2. The optical head of claim 1, wherein the lens is adjustable.

3. The optical head of claim, wherein the lens is a ball lens.

4. The optical head of claim 1, wherein the excitation light is provided by a LED.

5. The optical head of claim 1, wherein the excitation light is provided by a laser.

6. The optical head of claim 1 further including one or more filters.

7. The optical head of claim 6, wherein the one or more filters includes an emission filter and/or an excitation filter.

8. The optical head of claim 1 further including a lens block.

9. The optical head of claim 8, wherein the mirror and the beamsplitter are received in a first side of the lens block and the lens is in or on a second side of the lens block.

10. The optical head of claim 8, wherein the lens block includes a first lens block section configured to receive the light source, a second lens block section configured to receive one or more filters, and a third lens block section configured to receive the mirror and the beamsplitter.

11. The optical head of claim 8, wherein the first, second, and third lens block sections are secured to one another and positioned in the housing as a unit.

12. The optical head of claim 1, wherein the detector is a photodiode.

13. A small form factor optical head defining a single light pathway, comprising:
a housing;
a lens;
a light source positioned in the housing;
a photodiode positioned in the housing;
a lens block positioned in the housing;
a mirror positioned in the housing;
first and second filters positioned in the housing;
wherein the lens block is configured to receive the light source, the photodiode, the first and second filters, the mirror and the beamsplitter in a first side thereof and the lens is positioned at a second side thereof,
wherein the lens is configured to focus the excitation light and to allow emission light to pass through the lens,
wherein the beam splitter directs the excitation light toward the lens, and directs emission light to a detector.

14. The optical head of claim 13, wherein the single lens is a ball lens.

15. The optical head of claim 13, wherein the lens is adjustable.

16. A method for optical analysis, comprising:
providing an optical head having a housing, a lens positioned on or in the housing, a light source positioned in the housing, the light source configured to emit an excitation light, a mirror positioned in the housing to reflect the excitation light to the lens and to receive emission light back through the lens, a beamsplitter positioned in the housing to direct the excitation light to the lens and to direct the emission light, and a detector positioned to receive emission light after passing back through the lens and the beam splitter, wherein the lens, the mirror, and the beam splitter define a single light pathway for the excitation light and emission light;
emitting a light beam from the light source;
receiving an emission beam; and
analyzing the emission beam.
